(19) United States
(12) Patent Application Publication
(10) Pub. No.: US 2003/0028564 A1
(43) Pub. Date: Feb. 6, 2003

(54) Natural language method and system for matching and ranking documents in terms of semantic relatedness

(75) Inventor: Antonio Sanfilippo, Arlington, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA (US)

(21) Appl. No.: 10/029,377

(22) Filed: Dec. 19, 2001

Related U.S. Application Data
(60) Provisional application No. 60/257,060, filed on Dec. 19, 2000.

(51) Int. Cl. G06F 17/00

(52) U.S. Cl. 707/513

(57) ABSTRACT

A method and system are provided for matching a reference document with a plurality of corpus documents. Semantic content is derived from the reference document according to a hierarchical arrangement of semantic types. For each corpus document, semantic content is also derived from the corpus document according to the hierarchical arrangement of semantic types. A matching score is produced for each corpus document by determining a relatedness between the corpus document and the reference document. This relatedness is derived from the respective semantic contents of the two documents. The corpus documents may be ranked in accordance with the determined matching scores.

### CROSS-REFERENCES TO RELATED APPLICATIONS

This application is a nonprovisional of and claims priority to U.S. Prov. appl. No. 60/257,060 by Antonio Sanfilippo, filed Dec. 19, 2000, entitled “A NATURAL LANGUAGE METHOD FOR MATCHING AND RANKING A DOCUMENT COLLECTION IN TERMS OF SEMANTIC RELATEDNESS TO A REFERENCE DOCUMENT,” the entire disclosure of which is herein incorporated by reference in its entirety for all purposes.

This application is related to the following patent applications, the entire disclosure of each of which is herein incorporated by reference for all purposes:

U.S. Prov. appl. No. 60/110,190 by James D. Pustejovsky et al., filed Nov. 30, 1998, entitled “A NATURAL KNOWLEDGE ACQUISITION METHOD, SYSTEM, AND CODE”;

U.S. Prov. appl. No. 60/163,345 by James D. Pustejovsky, filed Nov. 3, 1999, entitled “A METHOD FOR USING A KNOWLEDGE ACQUISITION SYSTEM”;

U.S. Prov. appl. No. 60/228,616 by James D. Pustejovsky et a/, filed Aug. 28, 2000, entitled “ANSWERING USER QUERIES USING A NATURAL LANGUAGE METHOD AND SYSTEM”;

U.S. Prov. appl. No. 60/191,883 by James D. Pustejovsky, filed Mor. 23, 2000, entitled “RETURNING DYNAMIC CATEGORIES IN SEARCH AND QUESTION-ANSWER SYSTEMS”;

U.S. Prov. appl. No. 60/226,413 by James D. Pustejovsky et al., filed Aug. 18, 2000, entitled “TYPE CONSTRUCTION AND THE LOGIC OF CONCEPTS”;

U.S. application Ser. No. 09/433,630 by James D. Pustejovsky et al., filed Nov. 3, 1999, entitled “NATURAL KNOWLEDGE ACQUISITION METHOD”;

U.S. application Ser. No. 09/449,845 by James D. Pustejovsky et al., filed Nov. 26, 1999, entitled “NATURAL LANGUAGE ACQUISITION SYSTEM”;

U.S. application Ser. No. 09/449,848 by James D. Pustejovsky et al, filed Nov. 26, 1999, entitled “NATURAL KNOWLEDGE ACQUISITION SYSTEM COMPUTER CODE”;

U.S. application Ser. No. 09/662,510 by Robert J.P. Ingria et al., filed Sep. 15, 2000, entitled “ANSWERING USER QUERIES USING A NATURAL LANGUAGE METHOD AND SYSTEM”;

U.S. application Ser. No. 09/663,044 by Federica Busa et al., filed Sep. 15, 2000, entitled “NATURAL LANGUAGE TYPE SYSTEM AND METHOD”;

U.S. application Ser. No. 09/742,459 by James D. Pustejovsky et al., filed Dec. 19, 2000, entitled “METHOD FOR USING A KNOWLEDGE ACQUISITION SYSTEM”; and

U.S. application Ser. No. ______ by Marcus E. M. Verhagen et al., filed Jul. 3, 2001, entitled “METHOD AND SYSTEM FOR ACQUIRING AND MAINTAINING NATURAL LANGUAGE INFORMATION.”

### BACKGROUND OF THE INVENTION

The invention relates generally to the field of natural-language analysis of documents. More particularly, the invention relates to using natural-language analysis to match and rank documents.

There are numerous applications in which it is generally desirable to understand how individual documents are related in terms of their meaning, particularly where such understanding can be derived and applied systemically. Many of these applications derive from the recent proliferation of online textual information, which has intensified the need for efficient automated indexing and information retrieval techniques. Full-text indexing, in which all the content words in a document are used as keywords, was a promising automated approach, but suffers generally from mediocre precision and recall characteristics. The use of domain knowledge can enhance the effectiveness of a full-text system by providing related terms that can be used for broadening, narrowing, or refocusing queries, but such domain knowledge is substantially incomplete for many domains.

The usefulness of an automated system for ranking and matching documents within collections may be illustrated with a simple example in which it is desired to categorize a given document within an existing categorization scheme. While a human can examine the structure of the categorization scheme and evaluate the document to determine where in that scheme it should be classified, it would be very beneficial for a system to do so reliably in an automated way. Traditional machine-learning techniques are able to mimic the process taken by a human in categorizing the document, provided the number of categories is relatively small (≲100), the number of representative samples within each category is relatively large (≳30), and the representative samples are rich in content (≲100 words). In instances where any one of these factors is comprised, the reliability of a traditional machine-learning system for categorizing documents is severely hampered.

There is accordingly a general need in the art for providing a reliable method and system for matching and ranking documents.

### BRIEF SUMMARY OF THE INVENTION

Thus, embodiments of the invention provide a method and system for matching a reference document with a plurality of corpus documents. The method makes use of a natural-language knowledge acquisition system to derive semantic content from the documents and to define correlations between the documents in the form of a matching score.

Thus, in one embodiment, semantic content is derived from the reference document according to a hierarchical arrangement of semantic types. For each corpus document, semantic content is also derived from the corpus document according to the hierarchical arrangement of semantic types. A matching score is produced for each corpus document by determining a relatedness between the corpus document and the reference document. This relatedness is derived from the respective semantic contents of the two documents. The corpus documents may be ranked in accordance with the determined matching scores.

In some embodiments, the semantic content of the reference document or of the corpus document is derived by creating tokenized elements from a text stream extracted from the document. Each tokenized element is tagged with a grammatical category label and a root form is created for each tagged element. A semantic type from within the hierarchical arrangement may then be assigned to the root form.

In particular embodiments, the matching score is produced by determining a distance within the hierarchical arrangement between types defining semantic content of the reference and corpus documents. The distance may account for a qualia relationship between types, including direct and indirect qualia relationships and including telic and agentive qualia relationships. The matching score may also take account of whether the types are in a subsumption relationship. In one embodiment, a filtering function is applied to increase the importance of smaller distances relative to the importance of larger distances in producing the matching score. Suitable filtering functions include Gaussian, exponential, and rectangular functions.

In one embodiment, the plurality of corpus documents is categorized according to a categorization scheme and the reference document comprises an uncategorized document. The matching score is used to categorize the uncategorized document according to the categorization scheme. The categorization scheme may be hierarchical, in which case the plurality of corpus documents may be comprised by a larger set of documents within the hierarchical categorization scheme.

In another embodiment, the reference document may comprise a user query. The plurality of corpus documents may comprise a plurality of sponsor web pages so that an output interest statement may be generated to direct a user to a sponsor web page with semantic structures derived from the reference document and/or corpus documents.

In a further embodiment, the reference document and plurality of corpus documents are comprised by a document set. The matching scores are determined for a plurality of divisions of the document set into a reference document and corpus documents. Matching scores are combined for each document pair comprised by the document set. Documents are clustered within the document set by setting a threshold for the combined matching scores.

The methods of the present invention may be embodied in a system that includes a database and an engine in communication. The database may be configured to store a hierarchical arrangement of semantic types and the engine may be configured to implement aspects of the methods.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and is followed by a hyphen to denote one of multiple similar components. When reference is made to a reference numeral without specification to an existing sublabel, it is intended to refer to all such multiple similar components.

FIGS. 1A and 1B are schematic illustrations of how elements may be interconnected in different embodiments of the invention;

FIG. 2A provides an overview of a natural-language knowledge-acquisition system configured in accordance with an embodiment of the invention;

FIG. 2B provides an example of type structure that may be used with embodiments of the invention;

FIG. 3 illustrates a hierarchical type arrangement used by embodiments of the invention;

FIG. 4 is a flow diagram illustrating an embodiment for matching and ranking documents;

FIGS. 5A and 5B are flow diagrams illustrating details of the method for matching and ranking documents in specific embodiments;

FIG. 6 illustrates different types of filtering functions that may be used with embodiments of the invention;

FIG. 7A is a flow diagram illustrating an embodiment in which an uncategorized document is categorized;

FIG. 7B shows a hierarchical category structure that may be used for categorizing uncategorized documents;

FIG. 7C is a flow diagram illustrating an embodiment for categorizing uncategorized documents with the hierarchical category structure of FIG. 7B;

FIG. 8A is a flow diagram illustrating an embodiment in which search queries may be linked to sponsor web sites;

FIG. 8B provides an example of the embodiment illustrated in FIG. 8A; and

FIG. 9 is a flow diagram illustrating an embodiment in which a set of documents is clustered.

### DETAILED DESCRIPTION OF THE INVENTION

1. Introduction

Embodiments of the invention permit ranking a collection of documents in terms of semantic relatedness to a reference document. Each document in the collection and the reference document are first analyzed using a natural-language system to yield a content characterization. Such a content characterization recognizes each content word in the document, and possibly other objects such as picture and audio sequences, as semantic types with specific reference to their context of occurrence. Each document is thereafter described as a structured collection of semantic types.

Semantic relatedness is assessed by measuring the closeness of semantic types across each document in the collection and in the reference document. Each match between a collection document and the reference document yields a score that is derived to express a combined semantic relatedness of all semantic objects across the two documents. Once semantic relatedness between all documents in the collection and the reference document has been assessed, the resulting list of scores is ordered. This ordering provides a ranking of the document collection in terms of semantic relatedness to the reference document. In specific embodiments, the results are used to inform a general document categorization system to power a variety of applications, including document clustering, document routing, document retrieval, document summarization and information extraction, and automatic text categorization.

2. System Overview

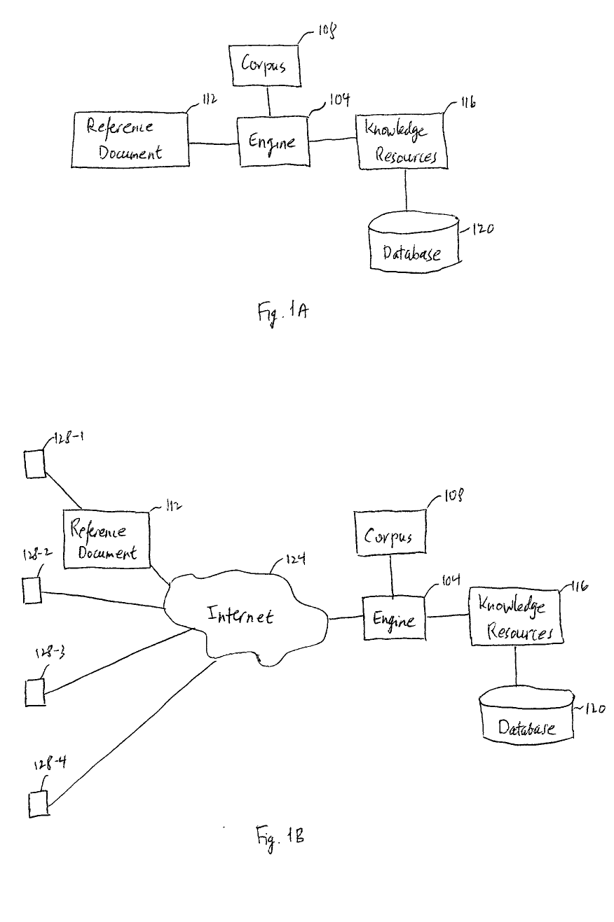

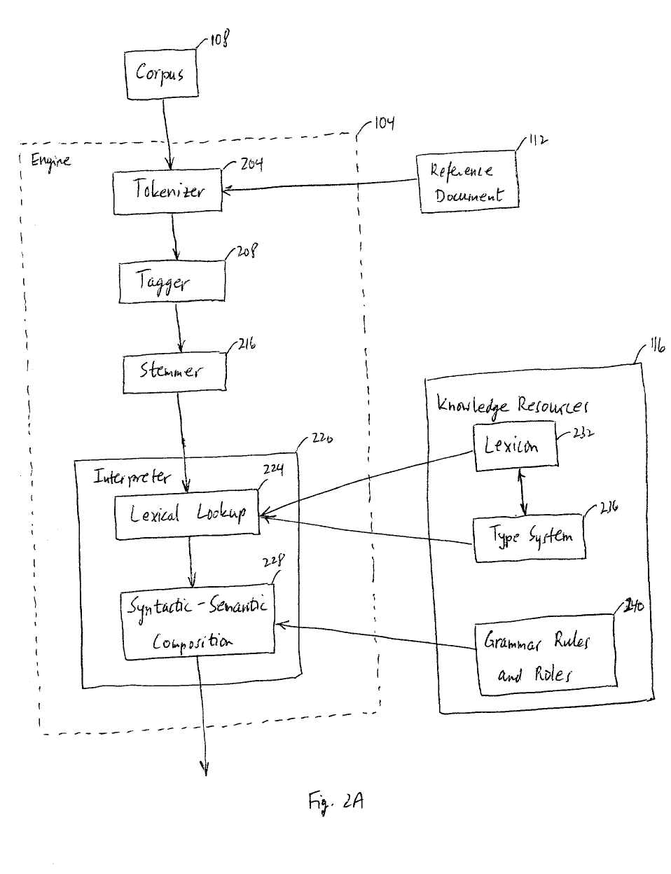

FIGS. 1A and 1B show simplified overviews of physical arrangements that can be used with embodiments of the invention. For both of the illustrated embodiments, a corpus 108 of text is provided to a natural-language engine 104. The corpus 108 generally includes a database of text, usually comprising a plurality of smaller documents that may range in size. The natural-language engine 104 is used to create a database 120 by accessing and using established knowledge resources 116. The database 120 is typically organized as a plurality of documents, which in one embodiment are structured into a hierarchical categorization scheme. Examples of how the natural-language engine 104 may function in this way are provided below for specific embodiments, but it may also operate according to other natural-language algorithms. Once the database 120 has been created, the natural-language engine 104 is prepared to consider reference documents 112, which can then be matched with documents comprised by the database 120 and ranked according to their relatedness.

In FIG. 1A, a reference document 112 is provided directly to the natural-language engine 104, while FIG. 1B illustrates an embodiment in which the reference document is instead provided to the natural-language engine 104 through the internet 124. In such an embodiment, both the natural-language engine 104 and a plurality of customers 128 are connected with the internet 124 so that the reference document may be generated and supplied by an individual customer 128-1. The different configurations of FIG. 1 may be more suitable for different types of applications embodied by the invention. In one embodiment, the reference document 112 is a natural-language search query, but as will be evident from the further discussion below, the invention encompasses more general types of reference documents.

3. Natural-Language Analysis

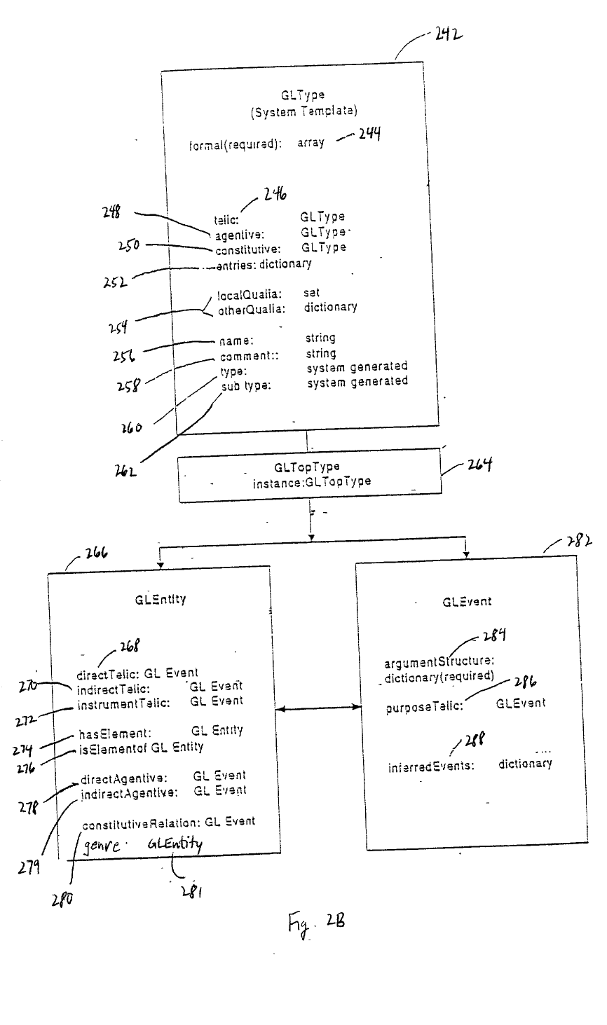

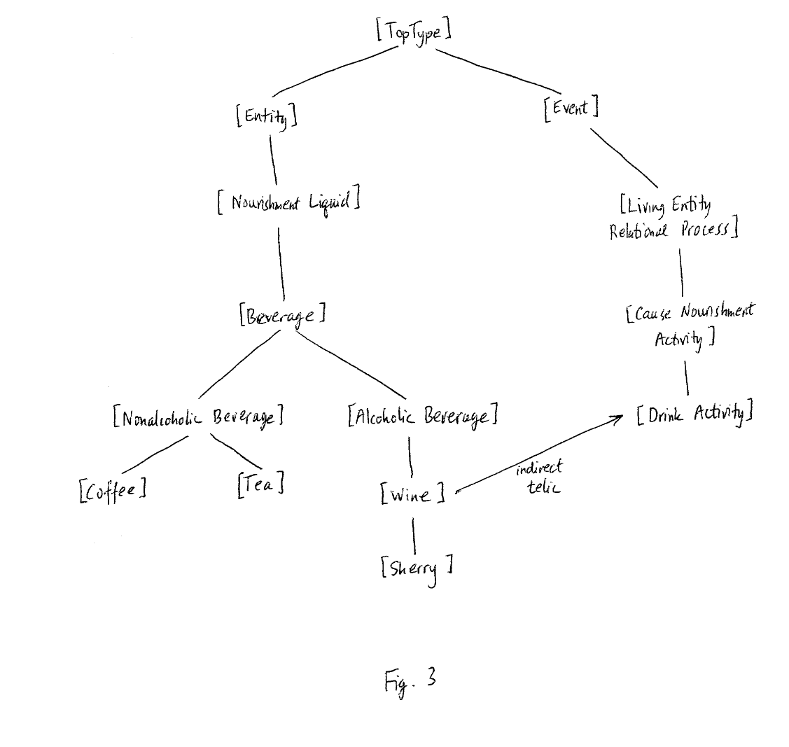

One embodiment that may be used for the natural-language analysis is illustrated in FIGS. 2A and 2B. FIG. 2A provides an expanded view of the natural-language engine 104 and illustrates one method by which the corpus 108 and/or reference document 112 may be analyzed. In the illustrated embodiment, the natural-language engine comprises a tokenizer 204, a tagger 208, a stemmer 216, and an interpreter 220. It is through the interpreter 220 that the natural-language engine 104 interacts with and receives information from the knowledge resources 116. The interpreter comprises a lexical lookup module 224 and a syntactic-semantic composition rules module 228. The knowledge resources 116 may comprise a lexicon 232 that interacts with a type system, as well as collection of grammar rules and roles 240. By processing the corpus 108 and/or reference document 112 with such a natural-language engine, both recognition of old concepts and phrases and understanding of new concepts and phrases can be automated.

The tokenizer 204 creates tokenized elements from a text stream extracted from the corpus 108 or reference document 112. The text stream may generally include words, punctuation, and numbers. The tokenized elements are created by dividing the text stream into subparts of orthographic words that are unbroken sequences of alphanumeric characters delimited by surrounding spaces, including stripping punctuation and apostrophes from words but preserving abbreviations and initials. Text that includes false punctuation, such as http: //www.company.com is not divided. The resulting set of orthographic words is then grouped into sentences.

The tagger 208 assigns a part-of-speech grammatical category label to each tokenized element in the tokenized text. In one embodiment, such a grammatical category label is derived from the Brill rule-based tagging algorithm. The tagger 208 comprises a tag dictionary containing a master list of words with corresponding tags to effect assignment of the category labels. The tagger 208 uses a set of lexical rules to guess the part of speech of a tokenized word and applies contextual rules that provide a means for interpreting words and tags according to context.

The stemmer 216 provides a system name to be used for retrieval of each element of the tokenized and tagged text. The stemmer 216 creates a root form for each orthographic word and assigns a numeric offset designating the position in the original text, such as by using a stem dictionary comprising a master list of stems. For example, in one embodiment, the stem dictionary includes two morphological dictionaries, one for verbs and one for nouns. If a particular token does not occur in the morphological dictionaries, it may be passed to a stripped-down version of the stemmer that strips off affixes in certain orthographic contexts. FIG. 1 of U.S. Prov. appl. No. 60/110,190 by James D. Pustejovsky et al., filed Nov. 30, 1998, entitled “A NATURAL KNOWLEDGE ACQUISITION METHOD, SYSTEM, AND CODE,” which has been incorporated herein by reference, provides an example of corpus that has been tokenized, tagged, and stemmed according to one embodiment.

The interpreter 220 is configured for at least two principal functions. First, the lexical lookup module 224 is configured for translation of the part-of-speech tags into fully specified syntactic categories and for using these syntactic categories to determine whether a particular stem is already known by the lexicon 232 and type system 236 of the knowledge resources 116. Generally, the lexicon 232 includes syntactic concepts, i.e. the words in the language, with a file for each part of speech, and the type system 236 describes semantic concepts. If the stem does exist within these knowledge resources, the syntactic and semantic information in the lexical entry is added to the syntactic category. If the stem is not known within these knowledge resources, the interpreter 220 adds default information.

Second, the interpreter is configured for parsing the syntactic categories with the syntactic-semantic composition module 228 to assemble syntactic compositions. This is achieved by applying the grammar rules and roles 240 to combine the syntactic categories into larger syntactic constituents. Application of these grammar rules and roles 240 with the output of the lexical lookup module 224 results in a meaning for the input text stream. Further features of the system illustrated in FIG. 2A, including specific grammar rules for one embodiment, are described in detail in commonly assigned U.S. Pat. application Ser. No. 09/449,845 by James D. Pustejovsky et al., filed Nov. 26, 1999, entitled “NATURAL LANGUAGE ACQUISITION SYSTEM,” the entire disclosure of which has been incorporated herein by reference.

In FIG. 2A, the major types of one embodiment are shown for illustrative purposes. Inheritance as used in object-oriented programming is used throughout the type structure. The root for the type system 236 is given by GLType 242 and provides the system template for an abstract characterization of the meanings of words. The root class instance is GLTopType 264. The structure includes two subclasses: GLEntity 266 to define entities, which may include nouns and adjectives, and GLEvent 282 to define events, which may include nouns, verbs, and adjectives. The subclasses GLEntity 266 and GLEvent 282 inherit characteristics such as member and member functions from the parent class GLType 242.

The organization embodied by the types structures an ontology along multiple dimensions, where each dimension corresponds to a different aspect of word meaning. As a result, each dimension involves a different way of understanding a given entity in the domain and thus involves a different set of queries concerning that entity. These different aspects of word meaning are expressed by a “qualia” structure, namely defining modes of understanding of an entity. A structured conceptual type involving qualia roles may be defined relative to the qualia roles “formal,” “constitutive,” “telic,” and “agentive,” which are described in further detail with respect to the type organization below. Qualia roles provide building blocks for structuring concepts, such that the types in the ontology may differ in terms of their internal complexity.

In the specific embodiment illustrated in FIG. 2B, the GLType 242 includes a required field and a plurality of optional fields. The required field is formal 244, corresponding to the formal qualia role, and is an array providing a unique identity for an entity and establishing the type/subtype relation between two types, thereby providing the key for performing inheritance. The remaining fields are optional:

(1) telic (GLType) 246, which corresponds to the telic qualia role, defines the purpose or function of the entity;

(2) agentive (GLType) 248, which corresponds to the agentive qualia role, defines how the entity comes into being;

(3) constitutive (GLType) 250, which corresponds to the constitutive qualia role, defines the mode of individuation of the entity, including the specific subparts that it comprises and the parts that comprise it;

(4) entries (dictionary) 252 defines words in the lexicon 232 associated with the type;

(5) localQualiao (set) and otherQualia (dictionary) 254 are open fields that provide for qualia in addition to formal, constitutive, agentive, and telic;

(6) name (string) 256 and comment (string) 258 are string fields that provide for a name and comment related to the entity; and

(7) type 260 and subtype 262 are system-generated fields that respectively define the type for the entity and a list of children types for the entity. In one embodiment, for each GLType, no more than one quale of each kind defined above is included, although multiples kinds of qualia may be included.

In the specific embodiment illustrated in FIG. 2B, the GLEntity 266 includes any or none of the following qualia relations, some of which correlate the GLEntity with a GLEvent and some of which correlate the GLEntity with other GLEntity's:

(1) direct Telic (GLEvent) 268, which defines what GLEvent is a function of the GLEntity;

(2) indirectTelic (GLEvent) 270, which defines what GLEvent is performed to the GLEntity;

(3) instrument Telic (GLEvent) 272, which defines what GLEvent is a use for the GLEntity;

(4) constitutive hasElement (GLEntity) 274, which defines apart of a larger group comprised by the entity;

(5) constitutive isElementof (GLEntity) 276, which defines a larger group that comprises the entity;

(6) directAgentive (GLEvent) 278, which defines a GLEvent that the GLEntity gives rise to;

(7) indirectAgentive (GLEvent) 279, which defines a GLEvent that gives rise to the GLEntity;

(8) constitutiveRelation (GLEvent) 280, which defines a relationship between the entity and what it is made of; and

(9) genre (GLEntity) 281, which groups entities that have something in common, such as types of books, music-store categories, store departments, etc.

In the specific embodiment illustrated in FIG. 2B, the GLEvent 282 includes one or more of the following fields:

(1) argumentstructure (dictionary) 284, which is a required field describing the semantic roles of a word to specify where it can be found in a sentence;

(2) purposeTelic (GLEvent) 286, which defines a purpose for the event; and

(3) inferredEvents (dictionary) 288, which defines an event that may be inferred from another event. The argument Structure 284 deals with the semantic roles of words and may be defined further. For example, in one embodiment, there may be two categories of roles —roles that reside in the type system 236 and argument roles that are properties of a lexical entry. Semantic roles used by the argumentStructure 284 include, but are not limited to:

(1) externalArgument (GLEntity), defining what performs the event;

(2) theme (GLEntity), defining what the event is performed on;

(3) goal (GLEntity), defining the result of the event on the theme; and

(4) locative (Area), defining where the event takes place. Argument roles may be defined by the following mappings in the lexicon 232 to the argumentStructure 284:

(1) subjectRole, which maps an argument of a sentence to the subject of the sentence or maps a noun to an adjective that modifies it;

(2) objectRole, which maps an argument of a sentence to the object of the sentence;

(3) ppHead, which is a preposition that defines the beginning of a prepositional phrase;

(4) ppRole, which describes an assignment role that the object of the prepositional phrase plays, and which is required whenever the ppHead mapping is used;

(5) clauseRole, which defines how to map a phrase in a sentence; and

(6) clauseComp, which is an optional field defining a related necessary clause.

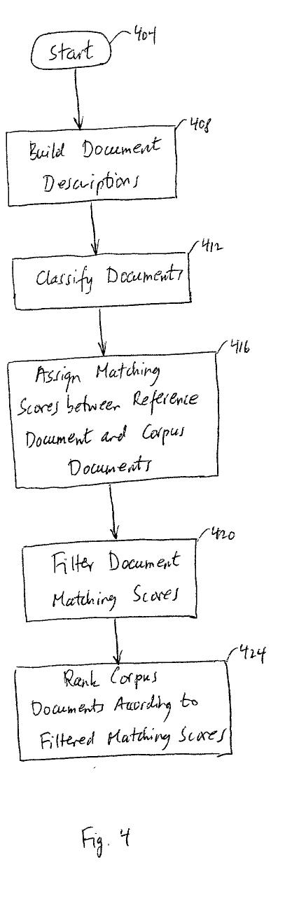

This formal structure may be understood further with a specific example, such as the one shown in FIG. 3. It will be understood that the tree structure shown in FIG. 3 represents merely a small portion of a much larger tree that corresponds to type hierarchy. Each of the types defined within the type hierarchy of FIG. 3 has lexical entries in the lexicon 232. For purposes of illustration, lexical entries for [Wine] and [Sherry] are set forth in Tables Ia and Ib respectively.

TABLE Ia
Lexical Entry for [Wine]

| | |
|---|---|
| type | [Wine] |
| formal | [Alcoholic Beverage] |
| agentive | [Wine-making Activity] |
| indirectAgentive | [Wine-making Activity] |
| indirectTelic | [Drink Activity] |
| made of | [Grape] |

TABLE Ib
Lexical Entry for [Sherry]

| | |
|---|---|
| type | [Fortified Wine] |
| formal | [Wine] |
| agentive | [Wine-making Activity] |
| indirectAgentive | [Wine-making Activity] |
| indirectTelic | [Drink Activity] |
| made of | [Grape] |

Using these exemplary lexical entries and applying the analysis of the natural-language engine 104 to the sentence The guests drank sherry results in the semantic structure set forth in Table II. This semantic structure exemplifies, among others, the theme and externalArgument relations by specifying the semantic dependency between the types for the words drink, sherry, and guest.

TABLE II
Semantic Structure of The guests drank sherry

type: [Drink Activity]
predicate: drink
theme: EntityLexLF

type: [Fortified Wine]
value: sherry

externalArgument: EntityLexLF

type: [Human Hospitality Role]
value: guest

The semantic dependencies permit a further illustration of how the natural-language engine 104 may extract relevant type pairs and singletons from semantic structures. Type pairs are represented as a sequence of two semantic types and arise from a combination of words or phrases that stand in a head-dependent relation, e.g. verb-subject, verb-object, noun-adjective, etc. Where either the head or the dependent type is not sufficiently informative, because it is too general, unknown, or otherwise, only the informative type is taken into account. If both members of the type pair are not sufficiently informative, the type pair is eliminated. Type singletons are simply all the types that arise from the semantic analysis and may derive from constituents that do not bind an argument, as in the case of noun or sentence conjuncts or from decomposing type pairs. Table III illustrates the type pairs and singletons that may be extracted from the semantic analysis of Table II.

TABLE III
Relevant Type Pairs and Singletons

| Type Singletons | Type Pairs |
|---|---|
| Drink Activity | Drink Activity - Fortified Wine |
| Fortified Wine | Drink Activity - Human Hospitality Role |
| Human Hospitality Role | |

4. Correlations Between the Corpus and the Reference Document

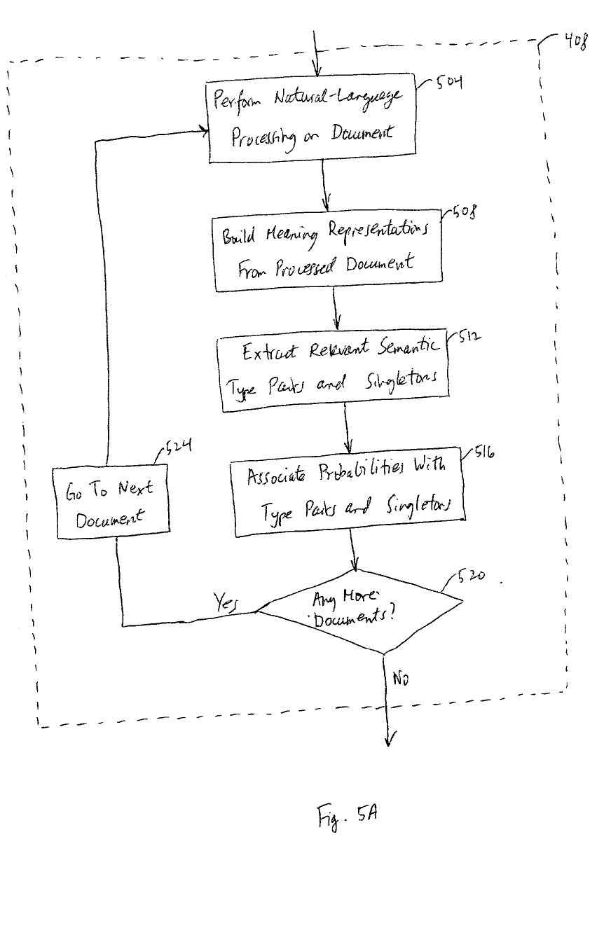

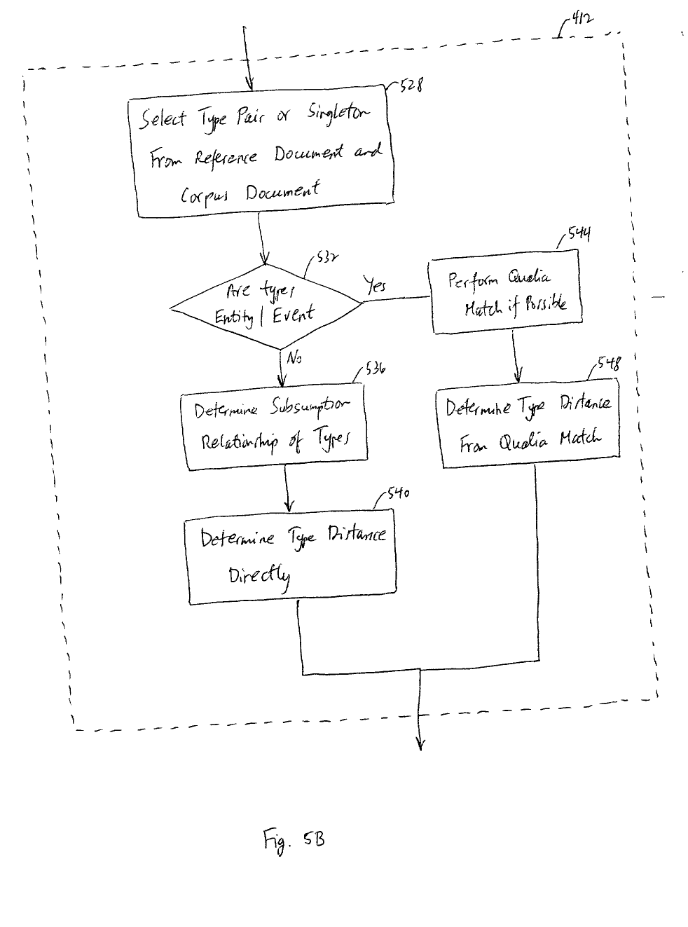

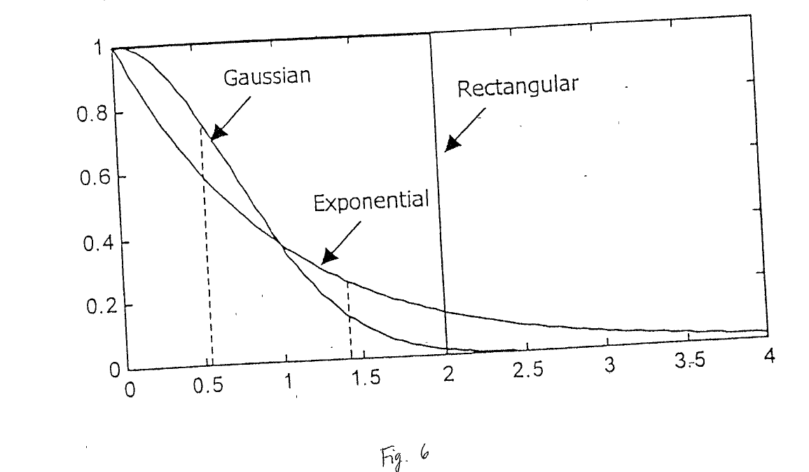

An overview of the method according to one embodiment for deriving and using correlations between documents comprised by the corpus 108 and the reference document 112 is shown with the flow diagram in FIG. 4. The method begins at block 404 and proceeds at block 408 by building document descriptions. One method for building such document descriptions is described in greater detail with respect to FIG. 5A below and uses the structure defined above. At block 412, the documents are classified based on their document descriptions so that matching scores may be assigned between the reference document 112 and documents comprised by the corpus 108 at block 416. As broadly defined, the matching scores define the degree of relevance each document in the corpus 108 has to the reference document 112. At block 420, noise is removed from the matching scores with a filter, which may be configured to increase the importance of smaller type distances and reduce the importance of larger type distances. At block 424, the corpus documents are ranked according to the filtered matching scores.

Various aspects of this method may be understood in greater detail in a specific embodiment with reference to FIGS. 5A and 5B. Block 408 of FIG. 4, corresponding to building document descriptions, is shown in greater detail in FIG. 5A. At block 504, for each of the documents comprised by the corpus 108 and for the reference document 112, natural-language processing is performed so that meaning representations may be built at block 508. Such natural-language processing may be performed with any appropriate natural-language knowledge-acquisition system, which in one embodiment is as set forth in FIG. 2A. In building meaning representations, the system may include a method for disambiguating words by choosing semantic types more appropriate to context.

At block 512, relevant type pairs and singletons are extracted from the documents so that probabilities can be associated with type pairs and singletons for each document at block 516. Such probability association may proceed in a number of different ways, but is correlated with the probability of a particular document description given a “type,” i.e. a type pair or singleton. This may be calculated as the probability p that the type occurs in association with the document description divided by the pure probability of the type:

The probability that the type occurs in association with the document description is determined by dividing the frequency f with which the type is found in the document description by the number of all possible pairwise combinations of document and types:

The pure probability of a type is calculated by dividing the frequency of the type by the frequency of all such types, i.e. pairs if the type is a type pair and singletons if the type is a type singleton:

These probability calculations may be illustrated with an example in which a corpus 108 includes 32 documents and in which the total number of type-pair occurrences as determined by executing blocks 504, 508, and 512 with a particular natural-language knowledge-acquisition system is 1814. If the specific type pair Appreciate Activity

Wine occurs three times in the corpus and occurs three times in association with the specific document D, then the probability of document D given the type pair Appreciate Activity-Wine is

After probabilities such as this one have been associated with type pairs and singletons for the particular document D, the system checks at block 520 whether all documents have been analyzed. If not, the process is repeated by moving to the next document at block 524.

Additional details of block 412 are shown for one embodiment in FIG. 5B, in which the documents are classified for determining the matching scores at block 416. At block 528, a first particular type try i.e. type pair or type singleton, is selected from the reference document and a second particular type t_{c} is selected from a corpus document. At block 532, a high-level determination is made regarding the relationship of the two types tᵣ and t_{c} since subsequent development of the matching score will depend on whether both types represent entities or events, or one type represents an entity and the other represents an event. In terms of the structure of FIG. 3, the distinction is drawn at the highest hierarchical level between types tᵣ and t_{c} that fall under the same or separate branches.

If the types share the highest hierarchical type of “event” or “entity,” the subsumption relationship of the types is determined at block 536. For example, in FIG. 3, [Wine] is subsumed by [Alcoholic Beverage] and [Beverage], but is not subsumed by [Nonalcoholic Beverage]. An intransitive subsumption multiplier x_{ISM} may be assigned depending on the subsumption relationship. In one embodiment, (1) if the subsuming type is found in the reference document 112 description, x_{ISM}=1; (2) if the subsuming type is found in the corpus 108 document description, x_{ISM}2; and (3) if there is no subsuming relationship, x_{ISM}=6. The values of x_{ISM} may differ in different embodiments, particularly to accommodate different fields of application.

At block 540, the type distance d_{rc} between tᵣ and t_{c} is determined directly. In one embodiment, such a direct determination is made for type singletons by counting the smallest number of links in the type hierarchy between tᵣ and t_{c}. For example, for the hierarchy illustrated in FIG. 3, d_{[Tea][Wine]}=4 and d_{[Tea][Sherry]}=5. When matching two type pairs and where and represent head components in a phrase while and represent dependents, the distance d_{rc} is given by adding the singleton distances between the head and dependent types across the two type pairs:

For example, for the hierarchy illustrated in FIG. 3,

For types sharing the highest hierarchical type, the raw matching score is given at block 416 by the product of the intransitive subsumption multiplier and the type distance:

By contrast, if the types do not share the highest hierarchical type so that one type is an event and one is an entity, the system seeks to perform qualia matching at block 544. Two types are deemed to be directly unmatchable if the only path to link them in the type hierarchy crosses the [Entity] and [Event] types, such as for [Wine] and [Drink Activity] in FIG. 3. In such instances, an indirect match is tried by taking into account the value of the types' telic and agentive qualia roles, which may be either direct or indirect. The indirect match includes matching the event type with each of event types contained in the telic and agentive qualia roles of the entity type. Thus, for example, [Wine] and [Drink Activity] in FIG. 3 provides an illustration of an indirect telic quale.

At block 548, the type distance is then determined from the qualia match. In one embodiment, type distances for indirect qualia type matches are normalized by a qualia distance multiplier x_{QDM} and a qualia additive distance d_{q}, both of which increase the yield of the normal distance function d_{rc}:

Thus, as an illustration, the type distance may be calculated in this way for the types [Wine] and [Cause Nourishment Activity] as they appear in the type hierarchy of FIG. 3 for specific values of the qualia distance multiplier and qualia additive distance, say x_{QDM}=2 and d_{q}=1. In this illustration, [Cause Nourishment Activity] appears in the reference document 112 description and [Wine] appears in the corpus 108 document description. The two types are directly unmatchable because the path of links that relates them crosses the [Entity] and [Event] types. Accordingly, the type distance separating them proceeds by matching [Drink Activity], the event type in the indirect telic qualia role of [Wine] as shown in Table Ia, with [Cause Nourishment Activity]. The distance between these two types is d_{rc}=1, so that

In some embodiments, a combined qualia distance is obtained by adding all single qualia distances. The raw matching score is then calculated at block 416 as above as a product of the type distance with the intransitive subsumption multiplier (for the specific embodiment described above).

After the raw matching score has been determined, either through a direct type distance determination or through a qualia match, it is filtered at block 420 of FIG. 4 to produce the final matching score. In one embodiment, the final matching score S_{rc} for a type tᵣ in a reference document 112 description and type t_{c} in a corpus 108 document description D is

where F is a filtering function.

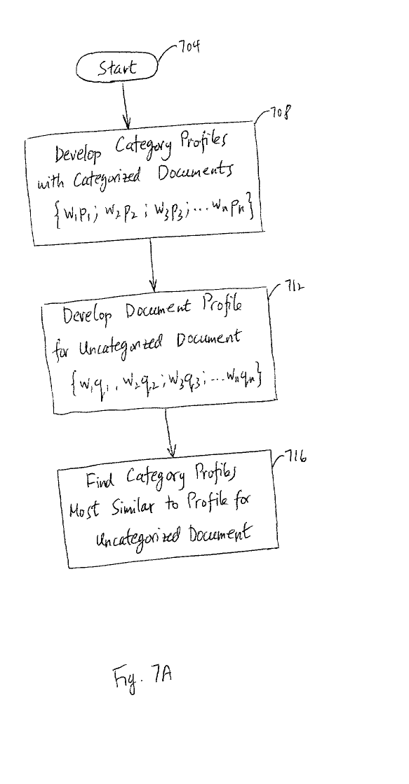

The filtering function F may be chosen differently in different embodiments, but will generally have the effect of increasing the importance of smaller type distances at the expense of larger type distances. Examples of different filtering functions are illustrated in FIG. 6.

Thus, for example, in one embodiment, the filtering is very strong in the sense that large type distances are completely excluded by using a rectangular filtering function

For this distribution, the standard deviation (“bandwidth”) is simply its distance extent (σₑ=a (=2 in FIG. 6). This standard deviation is no narrower than its spatial width so that, for σₑ=2 shown in FIG. 6, all distances less than 2 pass through the filtering function and all distances greater than 2 are rejected.

In another embodiment, the filtering function is an exponential which is shown in FIG. 6 for λ=1. The standard deviation of the exponential distribution is so that for λ=1,

In a further embodiment, the filtering function is a Gaussian

For the specific distribution shown in FIG. 6, the standard deviation is chosen to normalize the distribution such that A Gaussian filtering function has a tight distribution in the vicinity of 0 and has the smallest standard deviation of the three distributions shown in FIG. 6. In signal-processing terms, a Gaussian function has a very low bandwidth for its spatial width. In other words, it is a very narrow low-pass filter with low noise sensitivity and is therefore well suited for removing noise.

Example: Application of the filtering function may be illustrated with an example, such as a calculation of the final match score for the types [Beverage] and [Wine] according to the type hierarchy of FIG. 3. For purposes of illustration, the probability is taken to be 0.03125, a typical value derived for a specific exemplary case above. The distance between [Beverage] and [Wine] is 2. If the subsuming type [Wine] is in the reference document 112, the intransitive subsumption multiplier x_{ISM} is equal to 1 so that with a Gaussian filtering function having a standard deviation of, say,

If instead the subsuming type [Wine] is in the corpus 108 document, the intransitive multiplier x_{ISM} is equal to 2 so that the final matching score lower by roughly 50%:

In general, the absolute values of these final matching scores is not of particular relevance since the document ranking at block 424 of FIG. 4 requires only the relative scores. Similar application of the filtering function is used when the type distance results from a qualia match as described in detail above.

5. Exemplary Applications

a. Automatic Text Categorization

In one set of embodiments, the matching and ranking scheme described above is adapted for categorization of a document within an existing categorization scheme. Such categorization is useful in a number of contexts. For example, books may be organized in a bookstore or library according to some categorization scheme, which may be particularly extensive and have hundreds of thousands of possible categories. The system may be used to assign a new book to the appropriate category within the existing scheme. Similarly, music may be organized in a store or library according to a categorization scheme into which new pieces of music may similarly be categorized with the system. Essentially, in such embodiments, the uncategorized document serves as the reference document 112 and the collection of existing categories serves as the corpus 108.

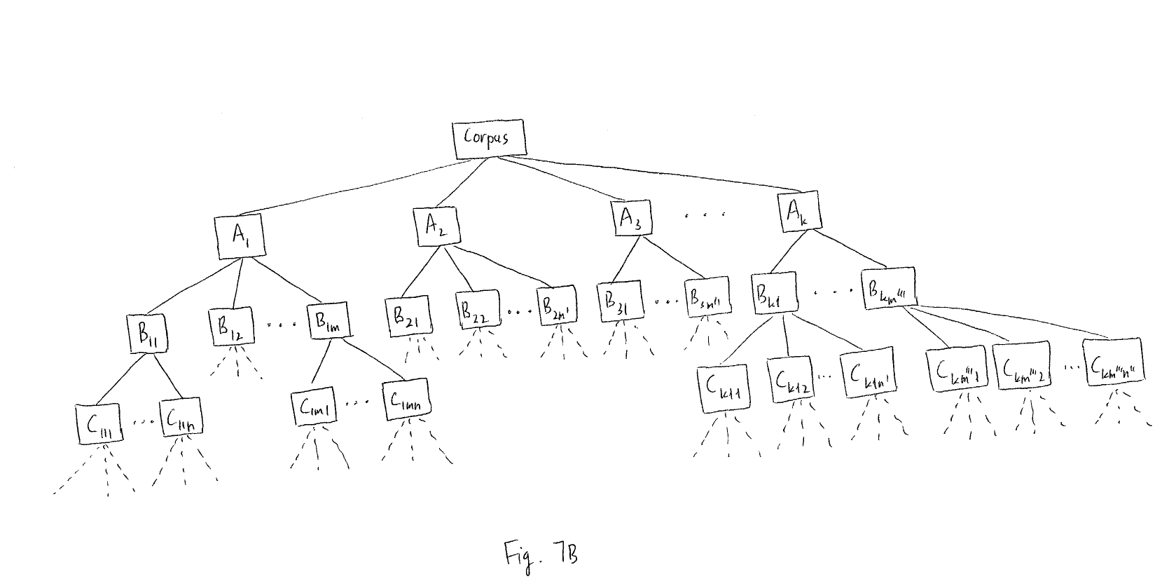

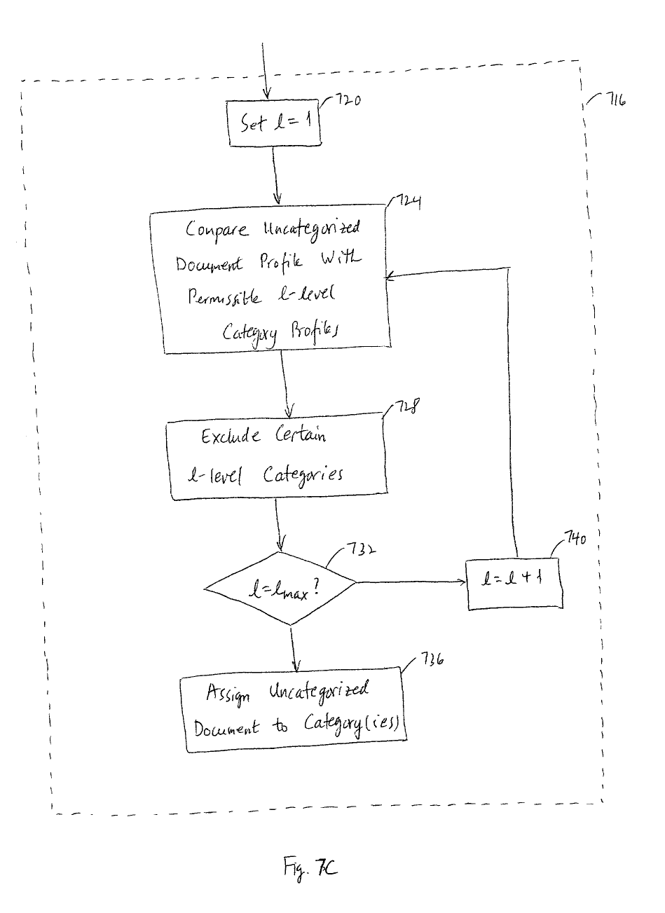

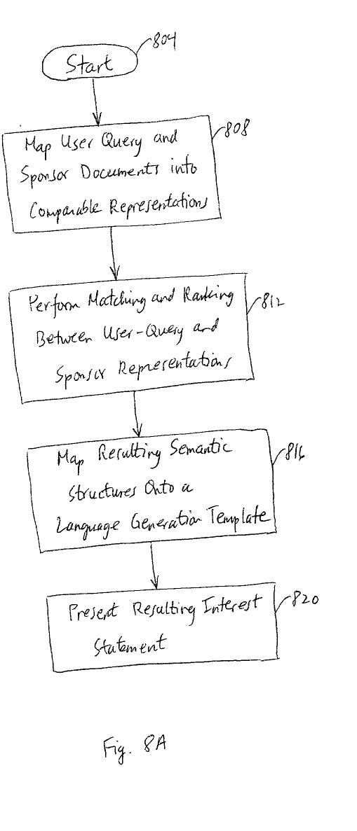

An overview of how the system may be configured for automatic text categorization is provided for one embodiment in FIG. 7A. Adaptation of the natural-language method and system described above to such an application tends to avoid certain limitations faced by machine-learning techniques. Such machine-learning techniques are typically capable of achieving high accuracy only when the number of categories is limited (≲100), the number of training samples for each category is large (≳30), and each training sample is rich in content (having ≳100 words). Such machine-learning techniques are thus generally poor when used for a categorization scheme that is disperse, having a large number of categories, few of which contain a large number of documents and few of which contain documents that are at all rich in content.

Thus, automatic text categorization starts at block 704 and proceeds to develop category profiles at block 708 from the corpus 108 of categorized documents. Each such category profile may comprise a set of words w₁, W₂, . . . , wₙ that are each associated with a respective probability of occurrence P₁, P₂, . . . Pₙ. Similarly, a document profile is developed at block 712 from the uncategorized reference document 112, associating a weight q with each of the words w. At block 716, category profiles most similar to the profile for the uncategorized document are found, permitting the uncategorized document to be categorized.

The method defined by blocks 708, 712, and 716 may be performed in one embodiment by applying the general method described above for matching and ranking documents. In finalizing the categorization, the system may be configured to select one or more categories in different ways in different embodiments. For example, if the categorization is required to be unique so that each document must be assigned to only a single category, the system may select the category providing the highest matching score to finalize the categorization. Alternatively, if assignment to multiple categories is permitted, the system may select all categories that provide a matching score that exceeds some threshold level. Other schemes to complete the category assignment after matching scores have been calculated and ranked are possible.

In one embodiment, the categorization scheme is structured hierarchically, which permits certain simplifications in the matching process. One example of a hierarchical categorization scheme is illustrated schematically in FIG. 7B. The corpus 108 is divided at a top level (l=1) into a number k of paramount categories (labeled “A”). Each of those paramount categories may itself be subdivided at a lower level (l=2, 3, . . . ) into a plurality of primary categories (labeled “B”), which may themselves be subdivided into a plurality of secondary categories (labeled “C”). This subdivision may have any number of levels and may terminate at different levels in the hierarchical scheme for different categories. If each level has an average of ten subdivisions, only six levels are required to provide a million categories.

FIG. 7C provides a flow diagram that illustrates one method by which the hierarchical arrangement can be exploited to reduce the category search space. FIG. 7C provides a detail of block 716 in one embodiment that is adapted for use with a hierarchical categorization scheme. At block 720 l, which represents the current hierarchical level being considered, is set equal to 1, i.e. for the top level. At block 724, the uncategorized document profile is compared with all permissible l-level category profiles. For l=1, all the category profiles may be permissible, but for other levels only a subset of the available categories may be permissible.

Thus, at block 728 certain of the l-level categories are excluded. In one embodiment, for example, all but a single one of the l-level categories, such as the one with the highest matching score, are excluded. In other embodiments, multiple l-level categories may remain unexcluded but simplification is still achieved by excluding some of the categories. If the lowest level in the hierarchy has not been reached, as checked at block 732, the next lower level in the hierarchy is considered at block 740. Having excluded certain of the categories at the higher level, the “permissible” categories at the new level consist of those that are directly subordinate to the unexcluded categories. The system proceeds in this way through all levels of the hierarchy so that only a relatively small portion of the structure need be studied to assign the uncategorized document at block 736.

b. Web Links to Sponsor Sites

In one embodiment, the method for matching and ranking documents is configured to provide links for web users to sponsor sites. A recurrent issue in web portals is how to provide direction to users to sponsor sites in response to queries so that, for example, the user may be directed to a suitable book-purchasing site in response to a query about a particular type of book. For such an implementation, the reference document 112 corresponds to the user's query and the corpus 108 corresponds to the collection of sponsor web pages. The matching and ranking provides an effective way to organize sponsor sites in terms of semantic relevance to the user's query by automatically factoring in both the sponsors' properties and the user's concerns.

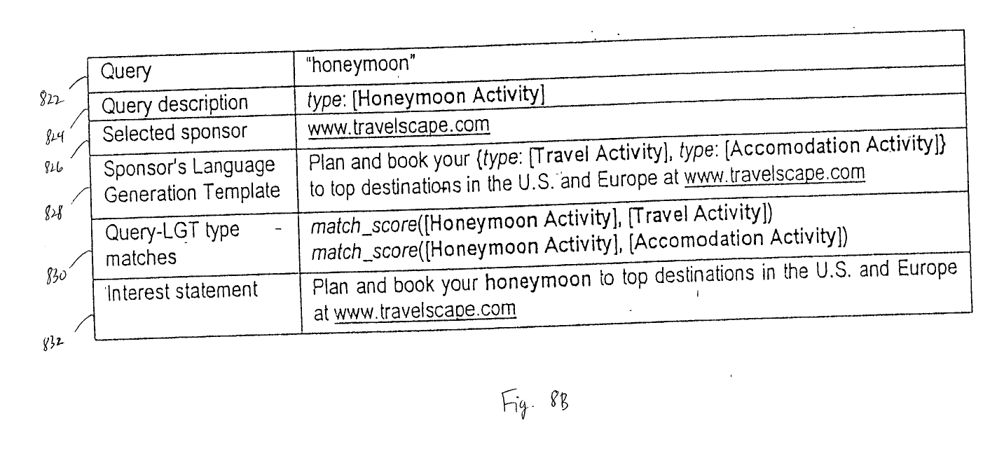

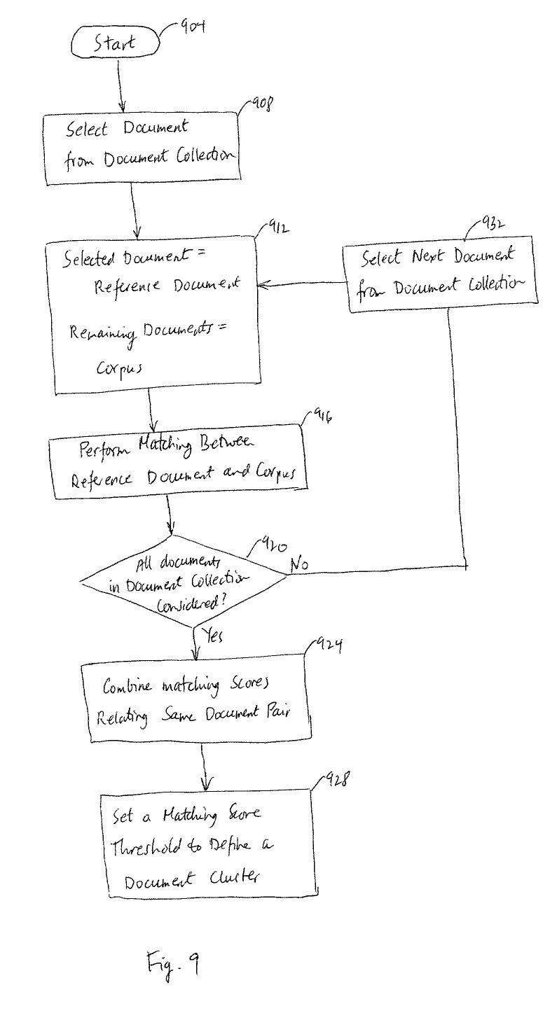

This application may be understood with reference to the flow diagram of FIG. 8A and the example provided in FIG. 8B. The method starts at block 804 and proceeds at block 808 to map the user query 822 and the sponsor documents into comparable semantic-type-based representations. In one embodiment, this is done with the natural-language knowledge acquisition system described above. The mapping permits establishing ranked query-to-sponsor links as the weighted match of semantic types across the query and sponsor descriptions. At block 812, such match and ranking is performed between the user-query and sponsor representations. The resulting semantic structures are then passed onto a template-based natural-language generation component to provide an output interest statement that closely reflects both the sponsors' properties and the user's concerns. At block 820, this resulting interest statement is presented to the user.

In the example of FIG. 8B, the simple user query 822 “honeymoon” is mapped into the query description 824 designating a type [Honeymoon Activity] and the sponsor 826 provides a language generation template 828 that includes the types [Travel Activity] and [Accommodation Activity]. In performing the matching and ranking at block 812, matching scores 830 are generated for the type pairs [Honeymoon Activity]-[Travel Activity]and [Honeymoon Activity]-[Accommodation Activity]. The best matching pair of types is selected, e.g. [Honeymoon Activity]-[Travel Activity], and is used to generate a word or phrase for the interest statement 832. This word or phrase may be derived from the initial query or may be derived from a pre-established list of type-word relations. If the former, the word or phrase selected is that that originates the query type giving a best fit with one of the types in the language generation template 828, i.e. “honeymoon” in the example.

c. Customer-Relation Management

In a further embodiment, the matching and ranking methodology is used to link user queries to a database of answers to “frequently asked questions” in an automated customer-relation management system. In this embodiment, the reference document 112 corresponds to the user's query and the corpus 108 corresponds to the set of records in the database of answers.

d. Query-Base Summarization

In still another embodiment, the matching and ranking methodology is used to retrieve a document summary that is most appropriate for a user's query. In this embodiment, the reference document 112 corresponds to the user's query and the corpus 108 corresponds to a set of sentences or other text units in the document to be summarized. In a specific aspect of this embodiment, the summary presented to the user is derived from the top-ranking sentences or other text units as determined by the matching and ranking procedure.

e. Document Clustering

In yet another embodiment, the matching and ranking methodology is used to cluster documents in a document collection. FIG. 9 illustrates a method for clustering documents in the form of a flow diagram by systemically matching each document in the collection with every other document in the collection. Thus, beginning at block 904, a first document is selected from the document collection at block 908. At block 912, the selected document is taken to comprise the reference document 112 and the remainder of the document collection is taken to comprise the corpus 108 so that matching may be performed as described above at block 916. At blocks 920 and 932 a check is made to determine whether all documents in the document collection have been considered as the reference document 112 and to select another document from the document collection if not.

It is evident that once all documents have been considered as the reference document 112, that a plurality of matching scores may exist relating a given document pair. Accordingly, at block 924, such matching scores are combined for each document pair, such as by averaging the matching scores. At block 928, a matching score threshold is set to define document clusters. All documents related by a matching score greater than the threshold are considered to be members of the same document cluster.

f. Document Retrieval

In a further embodiment, the matching and ranking methodology is used to link user queries to a database of documents. In this embodiment, the reference document 112 corresponds to the user's query and the corpus 108 corresponds to the set of records in the document database Documents are retrieved in order of fitness of match with the query.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for matching a reference document with a plurality of corpus documents, the method comprising:
deriving semantic content of the reference document according to a hierarchical arrangement of semantic types; and
for each corpus document,
deriving semantic content of the corpus document according to the hierarchical arrangement of semantic types; and
producing a matching score for the corpus document by determining a relatedness between the corpus document and the reference document from the derived semantic content of the corpus document and the derived semantic content of the reference document.

2. The method recited in claim 1 wherein deriving semantic content of the reference document and deriving semantic content of the corpus document comprises:
creating tokenized elements from a text stream;
tagging each tokenized element with a grammatical category label; and
creating a root form for each tokenized and tagged element.

3. The method recited in claim 2 wherein deriving semantic content of the reference document and deriving semantic content of the corpus document further comprises assigning a semantic type within the hierarchical arrangement of semantic types to the root form.

4. The method recited in claim 1 wherein producing the matching score comprises determining a distance within the hierarchical arrangement between a semantic type that defines semantic content of the reference document and a semantic type that defines semantic content of the corpus document.

5. The method recited in claim 4 wherein determining the distance comprises accounting for a qualia relationship between types in the hierarchical arrangement.

6. The method recited in claim 5 wherein the qualia relationship comprises a direct qualia relationship.

7. The method recited in claim 5 wherein the qualia relationship comprises an indirect qualia relationship.

8. The method recited in claim 5 wherein the qualia relationship comprises a telic relationship.

9. The method recited in claim 5 wherein the qualia relationship comprises an agentive relationship.

10. The method recited in claim 4 wherein producing the matching score further comprises accounting for whether the semantic type that defines semantic content of the reference document and the semantic type that defines semantic content of the corpus document are in a subsumption relationship.

11. The method recited in claim 4 wherein producing the matching score further comprises applying a filtering function to increase importance of a smaller distance relative to a larger distance.

12. The method recited in claim 11 wherein the filtering function comprises a Gaussian function.

13. The method recited in claim 11 wherein the filtering function comprises an exponential function.

14. The method recited in claim 11 wherein the filtering function comprises a rectangular function.

15. The method recited in claim 1 further comprising ranking the plurality of corpus documents in accordance with the matching score for each corpus document.

16. The method recited in claim 1 wherein the plurality of corpus documents is categorized according to a categorization scheme and the reference document comprises an uncategorized document, the method further comprising categorizing the uncategorized document according to the categorization scheme with the matching score.

17. The method recited in claim 16 wherein the categorization scheme comprises a hierarchical categorization scheme.

18. The method recited in claim 17 wherein the plurality of corpus documents is comprised by a larger set of documents within the hierarchical categorization scheme.

19. The method recited in claim 1 wherein the reference document comprises a user query.

20. The method recited in claim 19 wherein the plurality of corpus documents comprises a plurality of sponsor web pages, the method further comprising generating an output interest statement with semantic structures derived from at least one of the reference document and the corpus document having the highest matching score.

21. The method recited in claim 1 wherein the reference document and the plurality of corpus documents are comprised by a document set, the method further comprising:
determining the matching scores for a plurality of divisions of the document set into the reference document and the corpus documents;
combining the matching scores for each document pair comprised by the document set; and
clustering documents within the document set by setting a threshold for the combined matching scores.

22. A method for categorizing an uncategorized document within a categorization scheme, the method comprising:
deriving semantic content of the reference document according to a hierarchical arrangement of semantic types;
performing a comparison of the semantic content of the uncategorized document with semantic content of documents previously categorized according to the categorization scheme; and
determining a category for the uncategorized document from the comparison.

23. The method recited in claim 22 wherein the categorization scheme comprises a hierarchical categorization scheme.

24. The method recited in claim 23 wherein performing the comparison comprises, for each level of the hierarchical categorization scheme:
producing a matching score for each unexcluded document categorized at such level; and
excluding documents at a level subordinate to such level from the matching score.

25. The method recited in claim 22 wherein determining a category for the uncategorized document comprises determining a plurality of categories for the document.

26. The method recited in claim 22 wherein performing a comparison comprises producing a matching score for each of the plurality of documents previously categorized by determining a relatedness with the uncategorized document.

27. The method recited in claim 26 wherein producing the matching score comprises determining a distance within the hierarchical arrangement between a semantic type that defines content of the uncategorized document and a semantic type that defines semantic content of the previously categorized document.

28. The method recited in claim 27 wherein determining the distance comprises accounting for a qualia relationship between types in the hierarchical arrangement.

29. The method recited in claim 27 wherein producing the matching score further comprises accounting for whether the semantic type that defines semantic content of the uncategorized document and the semantic type that defines semantic content of the previously categorized document are in a subsumption relationship.

30. The method recited in claim 27 wherein producing the matching score further comprises applying a filtering function to increase importance of a smaller distance relative to a larger distance.

31. A system for matching a reference document with a plurality of corpus documents, the system comprising:
a database configured for storing a hierarchical arrangement of semantic types; and
an engine in communication with the database configured to
derive semantic content of the reference document and of each corpus document according to the hierarchical arrangement; and
produce a matching score between the reference document and each corpus document from the derived semantic content.

32. The system recited in claim 31 wherein the engine is further configured to rank each corpus document according to its matching score.

33. The system recited in claim 31 wherein the engine is configured to produce the matching score by determining a distance within the hierarchical arrangement.

34. The system recited in claim 33 wherein determining the distance comprises accounting for a qualia relationship between types in the hierarchical arrangement.

35. The system recited in claim 33 wherein the matching score is filtered to increase the importance of a smaller distance relative to a larger distance.

36. The system recited in claim 31 wherein the engine is in communication with the internet.

37. A system for categorizing an uncategorized document within a categorization scheme, the system comprising:
a database configured for storing a categorization for each of a plurality of previously categorized documents and for storing a hierarchical arrangement of semantic types; and
an engine in communication with the database configured to
derive semantic content of the uncategorized document and of each of the plurality of previously categorized documents according to the hierarchical arrangement; and
compare the semantic content of the uncategorized document with the semantic content of each of the plurality of previously categorized documents to determine a category for the uncategorized document.

38. The system recited in claim 37 wherein the categorization scheme comprises a hierarchical categorization scheme.

39. The system recited in claim 37 wherein the engine is configured to compare the semantic content by producing a matching score between the uncategorized document and each of the plurality of previously categorized documents.

40. The system recited in claim 39 wherein the engine is configured to produce the matching score by determining a distance within the hierarchical arrangement.

41. The system recited in claim 40 wherein determining the distance comprises accounting for a qualia relationship between types in the hierarchical arrangement.

42. The system recited in claim 40 wherein the matching score is filtered to increase the importance of a smaller distance relative to a larger distance.

43. The system recited in claim 37 wherein the engine is in communication with the internet.
